(19) United States
(12) Patent Application Publication
(10) Pub. No.: US 2023/0234158 A1
(43) Pub. Date: Jul. 27, 2023

(54) Resistance welding machine

(71) Applicant: Prima Srl, Albignasego (PD) (IT)

(72) Inventor: Guglielmo Doni, Albignasego (PD) (IT)

(21) Appl. No.: 18/011,862

(22) PCT Filed: Aug. 28, 2020
(86) PCT No.: PCT/IB2020/058036

§ 371 Date: Dec. 21, 2022

(30) Foreign Application Priority Data
Jun. 25, 2020 (IT) 102020000015286

(51) Int. Cl. B23K 11/11; B23K 11/31

(52) U.S. Cl. CPC B23K 11/11; B23K 11/312

(57) ABSTRACT

A resistance welding machine, particularly suited to carry out repairs on metallic bodies, includes a machine body housing a rechargeable electric battery for supplying the electrical energy that is necessary for the welding cycle, a rod carrying the welding electrode, and a rod carrying the earth electrode. Both of the earth rod and the welding rod are electrically connected to the battery, which is the only source of electrical energy for the resistance welding machine.

The present patent relates to electric resistance welding machines and in particular it concerns a new electric resistance welding machine powered by batteries, equipped with an electric battery particularly to conduct metal auto body repairs.

The high intensity of the current flowing through the two metal elements to be joined finds great resistance in the contact surfaces between the two metal elements, to the point of overheating and melting the metal of the contact surfaces of the two elements.

Generally the earth pole is securely connected, by means of a special copper clamp, to one of the two elements to be welded while the other electric pole, the positive pole, is applied with a suitable electrode to the second element already resting on the element connected to ground.

This type of welding is also used by autobody shops to conduct metal auto body repairs. In this case, the electric resistance welding machine is used to secure an element to a car frame and thus exert the necessary traction on the frame itself in order to reshape the deformed part.

In some conditions it is difficult to connect the negative pole with a clamp.

For example, when said resistance welding machines are used for repairing car bodies, it is often difficult to apply the negative clamp because the whole vehicle is painted and the paint does not allow or decreases the passage of the electric current.

In fact, usually the edges of the vehicle sheets are joined end to end without unpainted free edges and the few unpainted areas of the vehicle do not allow an adequate electrical connection with the point to be welded due to the presence of gaskets, joints with anti-vibration foams or the like, hinge lubricants, and anti-vibration or anti-friction supports.

These elements do not allow the adequate passage of current between the clamp and the welding point.

In this case it is therefore necessary to remove the paint not only from the deformed area to be repaired, but also from at least one other area, where the negative clamp can be applied.

A further drawback is the fact that the connection cable between the negative clamp and the welding machine often makes it difficult to carry out operations and limits the mobility of the welder.

Another drawback is the possibility that the welder inadvertently detaches the clamp from the negative connection, wasting time to reconnect it.

Another important drawback is the fact that said electric welding machines are powered by a cable connected to the electric power supply system, with obvious limitations on their range of action.

In order to obviate the aforesaid drawbacks, a new type of electric resistance welding machine was developed and constructed, particularly for carrying out metal auto body repairs, for lifting and leveling dents on metal sheets.

The main object of the present invention is to obtain a device which is easy to handle, as it does not have a negative clamp, and therefore not having the impediment of the presence of the connection cable to the negative clamp nor of the power supply cable connected to the electric power supply system.

Another object of the present invention is to further improve the manageability of the device, having reduced weight and dimensions with respect to the electric resistance welding machines in the prior art.

These and other direct and complementary objects are achieved by the new type of electric resistance welding machine, powered by internal batteries, specifically for carrying out metal auto body repairs, particularly for lifting and leveling dents on metal sheets.

The new electric resistance welding machine comprises a machine body which houses all the components necessary for the functioning of the welding machine, including the electric battery.

The new electric resistance welding machine comprises at least one welding electrode holder and at least one earth electrode holder, said electrode holders being inserted in corresponding seats or guides located on said machine body and arranged parallel to each other and side by side at a close distance.

Said earth electrode is preferably made of copper, while said welding electrode has a steel tip.

Said electrode holders are both connected, for example by means of a corresponding copper conductor, to one or more batteries of the welding machine contained in said machine body. Said electrode holders are telescopic and/or have the capacity to slide axially in said seats with respect to said machine body. Said electrode holders may, for example, have a total sliding stroke of 20-50 mm.

In particular, in the preferred embodiment, the earth electrode holder slides in an insulating tube inserted in the seat or guide, thus isolating the electrode holder from the machine body.

The welding electrode holder has a non-circular section, for example hexagonal, and is inserted in a guide bush with a seat having a shape corresponding to the section of said welding electrode holder, with an anti-rotation function to detach the tip from the sheet on which it was used at the end of the cycle.

On said welding electrode there is also an end-of-stroke stop element on which the pull strokes the welder makes to reshape the deformed part of the car body are discharged.

At least one elastic means or a compression spring is mounted inside each of said electrode seats, suited to counteract the sliding of said electrodes towards the inside of the machine body. Therefore, said two electrode holders are pushed outwards by said springs which also ensure the right load force for the electrical contact during the welding operation.

The close position of said two electrode holders enables the operator to ensure that both electrodes are in contact with the sheet to be worked without using connection clamps or the like.

The contact of both electrodes takes place close to each other and therefore it is sufficient to remove the paint only in correspondence with the area to be repaired and only for the limited surface needed.

The arrangement and the sliding stroke of these electrode holders also enables the welder to bring the new welding machine closer to the car body, with inclinations of up to 50 degrees with respect to the orthogonal position and with any angle of rotation with respect to the longitudinal axis of the welding machine.

The new electric resistance welding machine has no power supply cable connected to a power supply system and comprises the battery(ies) suitable for generating the welding voltage in the machine body; it works with MOSFET technology which facilitates the attainment of a device of reduced weight and dimensions compared to the electric resistance welders powered through cables of the prior art.

The characteristics of the new welder will be better explained by the following description with reference to the drawing, attached by way of a non-limiting example.

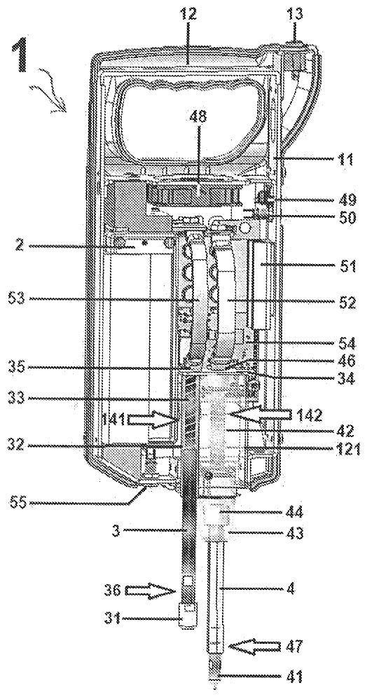

FIG. 1 shows a section of the new electric resistance welding machine (1).

The new electric resistance welding machine (1) is particularly suitable for conducting metal auto body repairs, for extracting and leveling dents of metal sheets.

The new electric resistance welding machine (1) comprises a machine body (11) with handle (12) near which at least one button (13) is positioned for switching the welding machine on and off.

The new electric resistance welding machine comprises at least one earth electrode holder (3), constrained at one end (35) to the machine body (11) in a sliding manner and comprising, at the opposite free end (36), the earth electrode (31).

The new electric resistance welding machine comprises at least one welding electrode holder (4), constrained at one end (46) to the machine body (11) in a sliding manner and comprising, at the opposite free end (47), the welding electrode (41).

Said earth electrode (31) is preferably made of copper, while said welding electrode (41) has a steel tip.

Said earth electrode (31) and welding electrode (41) are constrained to the relative electrode holders (3, 4) in a removable or non-removable manner.

Said earth electrode holder (3) and welding electrode holder (4) are both connected, for example by means of a corresponding copper conductor, to the rechargeable battery (2) of the welding machine contained in said machine body (11), which in turn can be connected to the electrical power source consisting of one or more batteries (2).

Said earth electrode holder (3) and welding electrode holder (4) are partly housed in corresponding seats or guides (141, 142) located in said machine body (11) and arranged parallel to each other and side by side at a close distance.

Said earth electrode holder (3) and welding electrode holder (4) are telescopic and/or axially sliding in said seats (141, 142) with respect to said machine body (11) independently of each other. Said electrode holders (3, 4) may, for example, have a total sliding stroke of 20-50 mm.

In order to isolate said earth electrode holder (3) from the machine body (11), said electrode holder (3) slides in an insulating tube (32), for example made of fiberglass with high thermal resistance, even up to 200° C., inserted in the relative seat or guide (142), and said end (35) of the earth electrode holder (3) constrained to the machine body (121) is housed in an insulating flange (34).

The welding electrode holder (4) has a non-circular section, for example hexagonal, and is inserted in a guide bush (43) preferably made of brass, with a seat having a shape corresponding to the section of said welding electrode holder (4), with an anti-rotation function to detach said welding electrode (41) from the sheet metal on which it was used at the end of the cycle.

There is also an end-of-stroke stop element (44) on said welding electrode (4) on which the pull strokes the welder makes to reshape the deformed part of the car body are discharged.

A compression spring (33, 42) is mounted inside each of said seats (141, 142) of the electrode rod holders (3, 4), suited to counteract the sliding of said electrode holders (3, 4) towards the inside of the machine body (11).

In the machine body itself there are one or more electric batteries (2) to supply all the electric energy necessary to perform the electric welding.

The batteries, preferably of the LI-PO type, are sized so as to provide sufficient autonomy to perform a suitable number of welds.

These specifications are sufficient for the expert person to construct the welding machine of the invention, and as a result, in the practical application there may be variations without prejudice to the substance of the innovative concept.

Therefore, with reference to the preceding description and the attached drawing the following claims are made.

1. A resistance welding machine comprising:
a machine body (11) housing one or more electric batteries (2),
a welding rod (4) carrying a welding electrode, the welding rod being constrained with one end (46) to the machine body (11) and comprising, at an opposite free end (47), the welding electrode or welding tip (41), and
an earth rod (3) carrying an earth electrode, the earth rod being constrained with one end (35) to the machine body (11) and comprising, at an opposite free end (36), an earth electrode or earth tip (31),
wherein both of said earth rod (3) and said welding rod (4) are electrically connected to at least one of said one or more batteries, and
wherein at least one of said one or more batteries (2) is an only source of electric current for a welding operation.

2. The resistance welding machine (1) according to claim 1, wherein the resistance welding machine comprises one or more MOSFET devices.

3. The resistance welding machine (1) according to claim 1, wherein said earth rod (3) and said welding rod (4) are arranged parallel to each other and side by side.

4. The resistance welding machine (1) according to claim 1, wherein one or both of said earth rod (3) and said welding rod (4) is/are telescopic and/or sliding and/or axially translating with respect to said machine body (11) independently of each other.

5. The resistance welding machine (1) according to claim 4, wherein each of said earth rod (3) and welding rod (4) is housed in a corresponding seat or guide (141, 142) obtained in said machine body (11).

6. The resistance welding machine (1) according to claim 5, wherein inside each of said seats (141, 142) where the welding and the earth rods (3, 4) slide there is a spring (33, 42) suited to counteract a sliding movement of said welding and said rods (3, 4) towards an inside of the machine body (11).

7. The resistance welding machine (1) according to claim 5, wherein said earth rod (3) slides within an insulating tube (32) inserted in the corresponding seat or guide (142).

8. The resistance welding machine (1) according to claim 1, wherein said welding rod (4) has a non-circular cross section and is inserted in a guide bushing (43) having a seat whose shape corresponds to a shape of the cross section of said welding rod (4), with an anti-rotational function, and wherein said welding rod is configured to have an end-of-stroke stop element (44) fixed thereto.

9. The resistance welding machine (1) according to claim 1, wherein said earth electrode (31) is made of copper and said welding electrode (41) comprises a steel tip.

10. The resistance welding machine (1) according to claim 1, wherein said machine body (11) comprises a grip (12), a button (13) for starting the welding machine being positioned adjacently to the grip.
